(19) United States
(12) Patent Application Publication
(10) Pub. No.: US 2010/0232559 A1
(43) Pub. Date: Sep. 16, 2010

(54) ION GENERATING DEVICE AND NEUTRON GENERATING APPARATUS

(75) Inventors: Masayuki Takeishi, Kobe (JP); Masanori Shimazaki, Kobe (JP); Masahito Shima, Kobe (JP); Tadashi Hasegawa, Tokyo (JP); Tetsuo Iguchi, Nagoya-shi (JP); Tatsuo Shoji, Nagoya-shi (JP); Kazuya Nishimura, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: MITSUBISHI HEAVY INDUSTRIES, LTD., Tokyo (JP); NATIONAL UNIVERSITY CORPORATION NAGOYA UNIVERSITY, Nagoya-shi, Aichi-ken (JP)

(21) Appl. No.: 12/303,861

(22) PCT Filed: Jun. 7, 2007
(86) PCT No.: PCT/JP2007/061540

§ 371 Date: Dec. 8, 2008

(30) Foreign Application Priority Data
Jun. 7, 2006 (JP) 2006-157952

(51) Int. Cl. H05H 3/06; H05H 1/46

(52) U.S. Cl. 376/108; 315/111.41; 250/423 R

(57) ABSTRACT

A neutron generating apparatus includes an ion generating device. The ion generating device includes an ion generating tube to which deuterium gas or tritium gas is supplied, a magnet arranged outside of the ion generating tube for generating a magnetic field in the ion generating tube, a plasma generating antenna arranged outside of the ion generating tube for generating an electric field in the ion generating tube, and an RF power source that supplies high frequency power to the plasma generating antenna. The RF power source supplies the high frequency power to the plasma generating antenna by controlling the pulse thereof so that an unsteady state of plasma is generated repetitively in the ion generating tube.

### TECHNICAL FIELD

The present invention relates to an ion generating device and a neutron generating apparatus, and, more particularly to an ion generating device that generates deuterium ions or tritium ions and a neutron generating apparatus that generates neutrons by a nuclear fusion reaction of deuterium or tritium.

### BACKGROUND ART

For example, as described in Patent Documents 1 and 2, there is a neutron generating apparatus that generates neutrons by nuclear fusion reaction of deuterium or tritium, by irradiating deuterium ion beams or tritium ion beams to a target occluding deuterium or tritium. When the neutrons generated by the neutron generating apparatus collide with a detection target object, gamma ray is radiated from the detection target object. The detection target object can be specified according to a type and intensity of the radiated gamma ray. Therefore, the neutron generating apparatus has been widely used for exploration of underground resources such as petroleum and checking of land mines or explosive compound in hand luggage at airports, and as a therapeutic neutron source.

Patent Document 1: Japanese Patent No. 3122081

Patent Document 2: Japanese Patent Application Laid-open No. H11-131199

### DISCLOSURE OF INVENTION

### Problem to be Solved by the Invention

To detect the gamma ray radiated from the detection target object reliably and in short timeframes, the amount of neutrons to collide with the detection target object needs to be increased. However, in the conventional neutron generating apparatus described in Patent Documents 1 and 2, in the case of deuterium-deuterium reaction, about 10⁶ per second has been the upper limit of the generation amount of neutrons. One factor causing this problem is that the number of ions, that is, an ion current extracted by the ion generating device that generates deuterium ions (tritium ions) is low. The generation amount of neutrons in the case of deuterium-tritium reaction has been about 10⁸ per second.

The present invention has been achieved in view of the above, and an object of the present invention is to provide an ion generating device and a neutron generating apparatus that can increase a generation amount of neutrons per unit time.

### Means for Solving Problem

To solve the problems as described above and to achieve an object, an ion generating device according to the present invention includes an ion generating tube to which deuterium gas or tritium gas is supplied, a magnet arranged outside of the ion generating tube and generates a magnetic field in the ion generating tube, a plasma generating antenna arranged outside of the ion generating tube and generates an electric field in the ion generating tube, and a high-frequency power source that supplies high frequency power to the plasma generating antenna, and the high-frequency power source supplies the high frequency power to the plasma generating antenna so that an unsteady state at a time of generating plasma is generated repetitively in the ion generating tube.

Further, according to the present invention, the high-frequency power source supplies the high frequency power intermittently to the plasma generating antenna, and a period for supplying the high frequency power once is set as a period for retaining the unsteady state at the time of generating the plasma in the ion generating tube.

According to the present invention, for example, the period for supplying high frequency power once can be set as the period for retaining an unsteady state at the time of generating plasma in the ion generating tube, and the high frequency power can be supplied to the plasma generating antenna intermittently, so that the unsteady state at the time of generating the plasma is repetitively generated in the ion generating tube, thereby enabling to generate the unsteady state in the ion generating tube at the time of generating the plasma more frequently per unit time. In this case, the maximum ion current value in the period for retaining the unsteady state at the time of generating the plasma is higher than the maximum ion current value in a period for retaining a steady state of the plasma. Therefore, by generating and retaining the unsteady state of the plasma more frequently per unit time in the ion generating tube, the ion current can be increased than a case that the steady state of the plasma is retained in the ion generating tube. Accordingly, the ion current per unit time can be increased.

Further, according to the present invention, because the unsteady state at the time of generating the plasma is repetitively generated to thereby generate the deuterium ions or tritium ions, heat generated in the ion generating device can be considerably decreased, as compared with a case that the steady state of the plasma is generated to thereby generate the deuterium ions or tritium ions. Therefore, the high frequency power, which increases the heat generated in the ion generating device, can be increased to thereby increase the maximum ion current value in the period for retaining the unsteady state at the time of generating the plasma. Accordingly, the ion current per unit time can be further increased.

Further, according to the present invention, the ion generating tube has an inner diameter D in a range equal to or larger than 15 millimeters and equal to or less than 25 millimeters.

According to the present invention, because the inner diameter D of the ion generating tube is decreased, a stress due to the heat generated in the ion generating tube can be decreased. Accordingly, a damage of the ion generating tube can be reduced.

Further, because the inner diameter D of the ion generating tube is decreased, electric field strength to be generated in the ion generating tube by the plasma generating antenna can be increased. Therefore, plasma density generated at the center of the ion generating tube can be improved, to thereby increase the maximum ion current value in the period of the unsteady state of the plasma. Accordingly, the ion current per unit time can be further increased.

Further, a neutron generating apparatus according to the present invention includes the ion generating device as described above, a source-gas supplying device that supplies deuterium gas or tritium gas to the ion generating device, a target arranged opposite to the ion generating device and occludes deuterium or tritium, an accelerator arranged between the ion generating device and the target and includes an accelerating electrode applied with voltage by an accelerating power source, a vacuum evacuation system that evacuates the accelerator, and an extraction electrode arranged between the ion generating device and the accelerator and applied with voltage by an extraction power source.

According to the present invention, because the ion current per unit time can be further increased, the generation amount of neutrons per unit time can be increased by increasing the amount of deuterium ions or tritium ions to collide with the target.

Further, according to the present invention, as the inner diameter D of the ion generating tube becomes smaller, the extraction power source increases the voltage to be applied to the extraction electrode.

Further, according to the present invention, as the high frequency power increases, the extraction power source increases the voltage to be applied to the extraction electrode.

According to the present invention, extraction voltage is increased according to the increase of the deuterium ions or tritium ions generated in the ion generating device. Therefore, the increased deuterium ions or tritium ions can be extracted efficiently from the ion generating device. Accordingly, the generation amount of neutrons per unit time can be reliably increased.

### EFFECT OF THE INVENTION

The ion generating device and the neutron generating apparatus according to the present invention repetitively generate an unsteady state at the time of generating the plasma in the ion generating tube, thereby enabling to increase the ion current per unit time and increase the generation amount of neutrons per unit time.

### BRIEF DESCRIPTION OF DRAWINGS

FIG. 1 is a configuration example of a neutron generating apparatus including an ion generating device according to the present invention.

FIG. 2 depicts a supply method of high frequency power.

FIG. 3 depicts an unsteady state of plasma.

FIG. 4 depicts a relationship between an ion current and an extraction voltage.

### EXPLANATIONS OF LETTERS OR NUMERALS

1 neutron generating apparatus
2 ion generating device
21 ion generating tube
22 magnet
23 plasma generating antenna
24 RF power source (high-frequency power source)
3 source-gas supplying device
31 source gas tank
32 gas-supply adjusting valve
33 supply tube
4 accelerator
41 metal tube
42 accelerating electrode
43 accelerating power source
44 diverging tube
5 vacuum evacuation system
6 extraction electrode
7 extraction power source
100 ground
200 detection target object

### BEST MODE(S) FOR CARRYING OUT THE INVENTION

Exemplary embodiments of the present invention will be explained below in detail with reference to the accompanying drawings. The invention is not limited to the embodiments. In addition, constituent elements in the embodiments include those that can be easily assumed by those skilled in the art or that are substantially equivalent.

### Embodiments

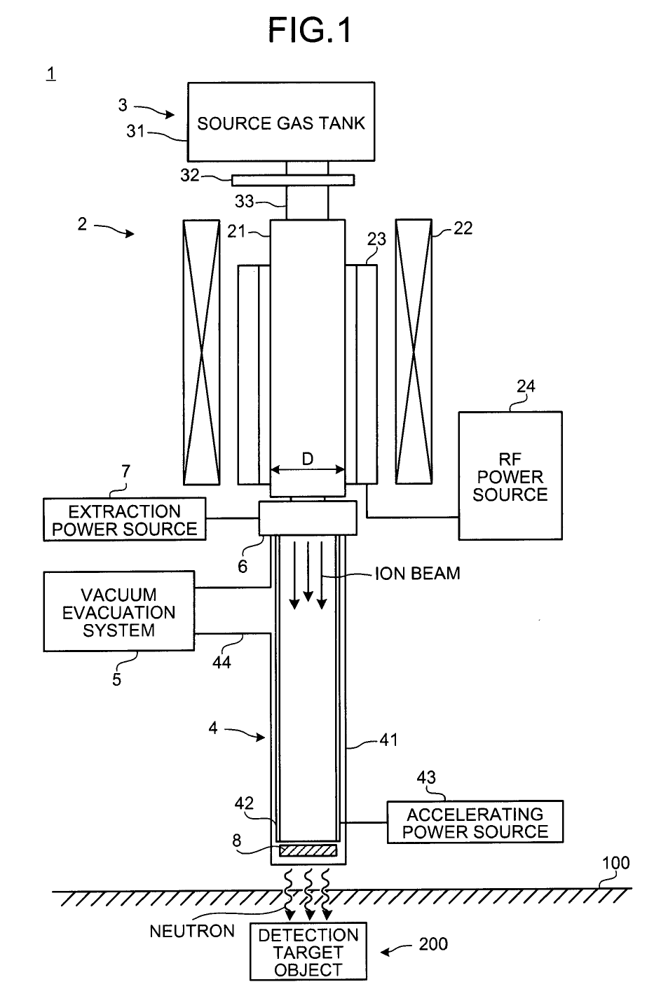

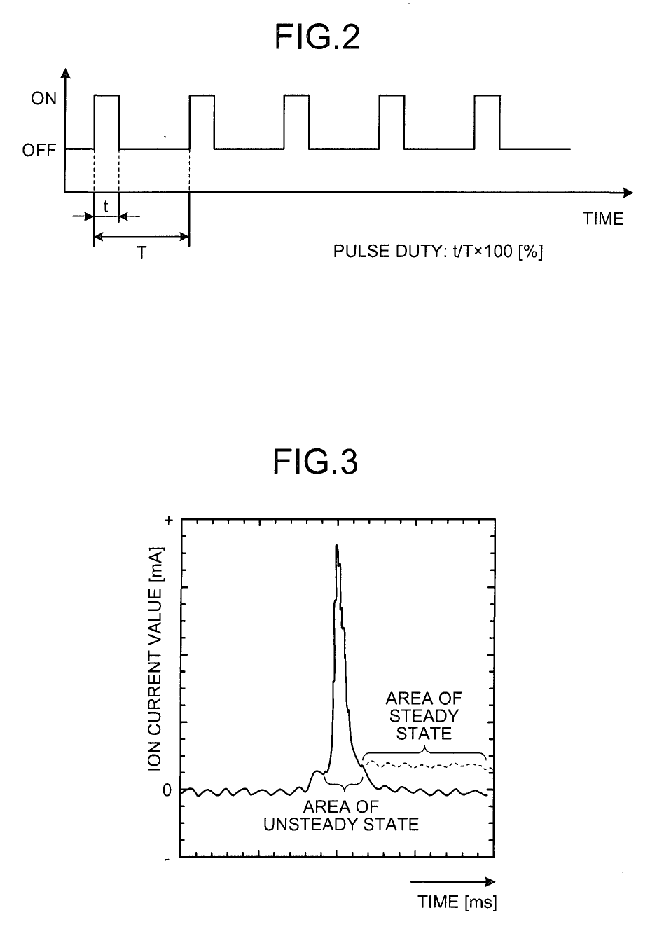

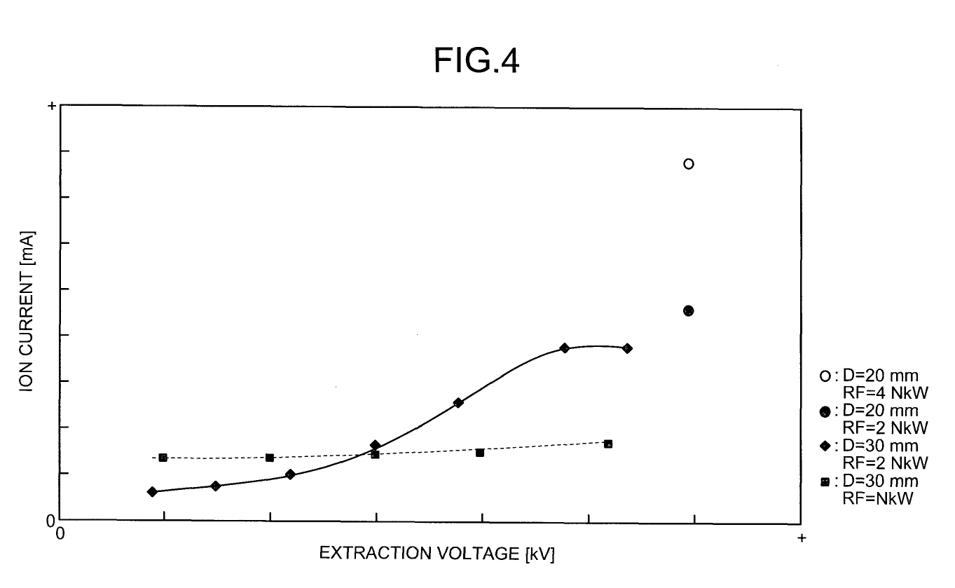

FIG. 1 depicts a configuration example of a neutron generating apparatus including an ion generating device according to the present invention. FIG. 2 depicts a supply method of high frequency power. FIG. 3 depicts the unsteady state of plasma. FIG. 4 depicts a relation between the ion current and the extraction voltage.

A neutron generating apparatus 1 includes, as depicted in FIG. 1, an ion generating device 2, a source-gas supplying device 3, an accelerator 4, a vacuum evacuation system 5, an extraction electrode 6, and an extraction power source 7. The neutron generating apparatus 1 causes neutrons to collide with a detection target object 200 such as underground resources, for example, petroleum buried in a ground 100 or an explosive substance such as the land mine. A detector that detects the gamma ray radiated from the detection target object 200 after the neutrons collide with the detection target object 200 can be integrally formed with the neutron generating apparatus 1 or can be formed separately.

The ion generating device 2 generates the plasma from deuterium or tritium to generate deuterium ions or tritium ions. The ion generating device 2 includes an ion generating tube 21, a magnet 22, a plasma generating antenna 23, and an RF power source 24.

The ion generating tube 21 is supplied with deuterium gas or tritium gas from the source-gas supplying device 3 and fills the deuterium gas or tritium gas to generate the plasma, to thereby generate the deuterium ions or tritium ions. The ion generating tube 21 has a cylindrical shape, with one end thereof being connected to the source-gas supplying device 3, and the other end being connected to the accelerator 4 via the extraction electrode 6. The length (axial length) of the ion generating tube 21 is not particularly specified, however, it is preferred that the length be equal to or less than 300 millimeters, taking downsizing of the neutron generating apparatus 1 into consideration.

An inner diameter D of the ion generating tube 21 is preferably in a range equal to or larger than 15 millimeters and equal to or less than 25 millimeters. If the inner diameter D of the ion generating tube 21 is smaller than 15 millimeters, the deuterium gas or tritium gas is hardly supplied from the source-gas supplying device 3, and it becomes difficult to fill the inside of the ion generating tube 21 with the deuterium gas or tritium gas sufficiently. If the inner diameter D of the ion generating tube 21 exceeds 25 millimeters, it is difficult to increase the electric field strength to be generated in the ion generating tube 21 by the plasma generating antenna 23. It is further preferred that the inner diameter D of the ion generating tube 21 be in a range equal to or larger than 18 millimeters and equal to or less than 225 millimeters.

The magnet 22 generates a magnetic field in the ion generating tube 21. The magnet 22 is arranged outside of the ion generating tube 21. In the present embodiment, the magnet 22 is a permanent magnet, and is arranged to cover the outer circumference of the ion generating tube 21. The magnet 22 can be an electromagnet.

The plasma generating antenna 23 generates the electric field in the ion generating tube 21 by the high frequency power supplied from the RF power source 24. The plasma generating antenna 23 is arranged outside of the ion generating tube 21. In the present embodiment, the plasma generating antenna 23 is a helicon wave antenna, and is arranged between the ion generating tube 21 and the magnet 22 to cover the outer circumference of the ion generating tube 21.

The RF power source 24 is a high-frequency power source and supplies the high frequency power to the plasma generating antenna 23. The high frequency power has a frequency capable of generating the helicon wave, in the present embodiment, by being supplied to the plasma generating antenna 23. For example, the high frequency power is several kilowatts power having several to ten-odd megahertz. In the present embodiment, as shown in FIG. 2, the RF power source 24 supplies the high frequency power to the plasma generating antenna 23 by controlling the pulse thereof. That is, the RF power source 24 intermittently supplies the high frequency power to the plasma generating antenna 23.

The source-gas supplying device 3 supplies the deuterium gas or tritium gas to the ion generating device. The source-gas supplying device 3 includes a source gas tank 31, a gas-supply adjusting valve 32, and a supply tube 33.

The source gas tank 31 stores the deuterium gas or tritium gas, which is an ion source. The source gas tank 31 is connected to the ion generating tube 21 via the supply tube 33.

The gas-supply adjusting valve 32 adjusts a feed rate of the deuterium gas or tritium gas supplied to the ion generating tube 21. The gas-supply adjusting valve 32 is provided halfway of the supply tube 33. The gas-supply adjusting valve 32 adjusts the feed rate, thereby enabling to adjust the inside of the ion generating tube 21 to have a density at which the plasma is likely to be generated.

The accelerator 4 accelerates the deuterium ions or tritium ions generated by the ion generating device 2 to generate deuterium ion beams or tritium ion beams. The accelerator 4 includes a metal tube 41, an accelerating electrode 42, an accelerating power source 43, and a diverging tube 44.

The metal tube 41 has a cylindrical shape. One end thereof is connected to the ion generating tube 21 via the extraction electrode 6, and the other end is blocked. The accelerating electrode 42 and a target 8 are housed in the metal tube 41.

When the voltage is applied to the accelerating electrode 42, the accelerating electrode 42 accelerates the deuterium ions or tritium ions extracted from the ion generating tube 21 into the metal tube 41. The accelerating electrode 42 has a cylindrical shape, and is arranged between the ion generating device 2 and the target 8.

The accelerating power source 43 applies the voltage to the accelerating electrode 42. The voltage is, for example, about several hundred kilovolts. The polarity thereof can accelerate the deuterium ions or tritium ions from the ion generating device side toward the target side. That is, when the accelerating power source 43 applies the voltage to the accelerating electrode 42, the deuterium ions or tritium ions extracted into the metal tube 41 are accelerated in the metal tube 41 toward the target 8.

One end of the diverging tube 44 is connected to the vacuum evacuation system 5, and the other end communicates with the metal tube 41.

The vacuum evacuation system 5 evacuates the accelerator 4. The vacuum evacuation system 5 is formed of, for example, an air displacement pump (not shown). By driving the air displacement pump (not shown), the gas in the metal tube 41 is evacuated to create a vacuum therein. The vacuum evacuation system 5 can evacuate the ion generating tube 21 as well, which is connected to the metal tube 41.

When the voltage is applied to the extraction electrode 6, the extraction electrode 6 extracts the deuterium ions or tritium ions from the plasma generated in the ion generating tube 21 to the accelerator 4. The extraction electrode 6 is arranged between the ion generating device 2 and the accelerator 4.

The extraction power source 7 applies the voltage to the extraction electrode 6. The voltage is, for example, about several to ten-odd kilovolts. The polarity thereof can move the deuterium ions or tritium ions from the ion generating device toward the accelerator side. That is, when the voltage is applied to the extraction electrode 6 from the extraction power source 7, the deuterium ions or tritium ions are extracted from the plasma generated in the ion generating tube 21 to the accelerator 4.

An operation of the neutron generating apparatus 1 including the ion generating device 2 according to the present invention is explained next. Further, the source-gas supplying device 3 supplies deuterium or tritium to the ion generating device 2. At this time, the vacuum evacuation system 5 is driven, and the metal tube 41 of the accelerator 4 and the ion generating tube 21 are evacuated. Accordingly, the deuterium or tritium in the source gas tank 31 is supplied to the ion generating tube 21 in a state with the feed rate thereof being adjusted by the supply tube 33 by opening the gas-supply adjusting valve 32.

The plasma is generated from the deuterium or tritium supplied to the ion generating tube 21. The plasma is generated by moving electrons in the ion generating tube 21 rapidly by the power of the magnetic field generated in the ion generating tube 21 by the magnet 22 and the electric field generated in the ion generating tube 21 by the plasma generating antenna 23 supplied with the high frequency power by the RF power source 24.

The RF power source 24 supplies the high frequency power to the plasma generating antenna 23 so that the unsteady state at the time of generating the plasma in the ion generating tube 21 can be repetitively generated. In the plasma generated in the ion generating tube 21, as shown in FIG. 3, there are the unsteady state and the steady state (dotted line in FIG. 3). The unsteady state at the time of generating the plasma is a transient response at the time of generating the plasma, and has higher maximum ion current value than that in the steady state. That is, the maximum ion current value in the period for retaining the unsteady state at the time of generating the plasma is higher than that in the period for retaining the steady state of the plasma. As shown in FIG. 3, the RF power source 24 supplies the high frequency power to the plasma generating antenna 23 by controlling the pulse thereof, so that the period for supplying the high frequency power once becomes the period during which the unsteady state at the time of generating the plasma can be generated and retained. Specifically, as shown in FIG. 2, the RF power source 24 adjusts a pulse frequency for repeating ON/OFF of the high frequency power and a pulse duty t/T×100(%), which is a ratio of a period t for supplying the high frequency power to one cycle T, so that the period t for supplying the high frequency power becomes the period for retaining the unsteady state at the time of generating the plasma. Accordingly, the unsteady state at the time of generating the plasma is generated repetitively according to the pulse frequency in the ion generating tube 21. That is, the period for retaining the unsteady state at the time of generating the plasma, having the maximum ion current value higher than that in the period for retaining the steady state of the plasma can be generated more frequently per unit time in the ion generating tube 21. Accordingly, the ion current per unit time can be increased than a case that the steady state of the plasma is retained in the ion generating tube 21, and the ion current per unit time can be increased.

A longer period for retaining the steady state of the plasma in the ion generating tube 21 increases the heat generated in the ion generating device 2, particularly, in the ion generating tube 21. However, in the ion generating device 2 according to the present invention, because the period for retaining the unsteady state at the time of generating the plasma is repetitively generated in the ion generating tube 21, the heat generated in the ion generating device 2 can be considerably decreased as compared with a case for retaining the steady state of the plasma. Accordingly, the high frequency power, which increases the heat generated in the ion generating device 2, can be increased, and the maximum ion current value in the period for retaining the unsteady state at the time of generating the plasma can be increased. Accordingly, the ion current per unit time can be increased.

The period t for supplying the high frequency power is preferably equal to or substantially equal to the period of the unsteady state at the time of generating the plasma. That is, it is preferred that the steady state of the plasma is not retained in the ion generating tube 21 by supplying the high frequency power to the plasma generating antenna 23, in the period t during which the RF power source 24 supplies the high frequency power.

Because the inner diameter D of the ion generating tube 21 is in the range equal to or larger than 15 millimeters and equal to or less than 25 millimeters, the strength of the electric field generated in the ion generating tube 21 can be increased by the plasma generating antenna 23 to which the high frequency power is applied, as compared with the ion generating tube having the inner diameter D exceeding 25 millimeters. Accordingly, the density of the plasma generated at the center of the ion generating tube 21 can be improved and the maximum ion current value in the period of the unsteady state of the plasma can be increased. Accordingly, the ion current per unit time can be increased.

Further, the stress due to the heat generated in the ion generating tube 21 can be reduced as compared with the ion generating tube having the inner diameter D exceeding 25 millimeters. Accordingly, a damage of the ion generating tube 21 can be reduced. Because a smaller inner diameter D of the ion generating tube 21 decreases the stress due to the heat, the high frequency power, which increases the heat generated in the ion generating device 2, can be increased, and the maximum ion current value in the period of the unsteady state of the plasma can be increased. Accordingly, the ion current per unit time can be increased.

The deuterium ions or tritium ions are then extracted from the plasma generated in the ion generating tube 21 to the accelerator 4. In this case, the extraction power source 7 applies the voltage to the extraction electrode 6. The deuterium ions or tritium ions in the plasma generated in the ion generating tube 21 are attracted to the extraction electrode 6 applied with the voltage, and extracted from the ion generating tube 21 to the accelerator 4. If only the plasma having low density or plasma having less density is generated in the ion generating tube 21, that is, if the extractable deuterium ions or tritium ions are few, the amount equal to or more than the deuterium ions or tritium ions generated in the ion generating tube 21 cannot be extracted even if the voltage of the extraction electrode is raised.

However, in the ion generating device 2 according to the present invention, as the high frequency power to be supplied to the plasma generating antenna 23 increases, and as the inner diameter D of the ion generating tube 21 becomes smaller, the density of the plasma generated at the center of the ion generating tube 21 can be improved and more plasma can be generated. That is, the extractable deuterium ions or tritium ions can be increased. Accordingly, as the inner diameter D of the ion generating tube 21 becomes smaller, the extraction power source 7 increases the voltage to be applied to the extraction electrode 6. Further, as the high frequency power to be supplied to the plasma generating antenna 23 increases, the extraction power source 7 increases the voltage to be applied to the extraction electrode 6. That is, by increasing the extraction voltage according to an increase of the extractable deuterium ions or tritium ions generated in the ion generating device 2, the increased deuterium ions or tritium ions can be efficiently extracted from the ion generating device 2.

For example, as shown in FIG. 4, if the inner diameter D of the ion generating tube 21 is 30 millimeters and high frequency power RF to be supplied from the RF power source 24 to the plasma generating antenna 23 is N (kW), ion current (mA) hardly increases (dotted line in FIG. 4) even if the voltage (kV) of the extraction electrode 6 is increased. However, if the inner diameter D is 30 millimeters and the high frequency power RF is increased from N (kW) to 2N (kW), because the high frequency power increases, the ion current (mA) can be increased by increasing the voltage (kV) of the extraction electrode 6 (solid line in FIG. 4). However, the ion current (mA) hardly increases only by increasing the high frequency power, when the voltage (kV) of the extraction electrode 6 is increased to some extent.

Therefore, if the inner diameter D of the ion generating tube 21 is decreased from 30 millimeters to 20 millimeters and the high frequency power RF is 2N (kW), because the density of the plasma generated at the center of the ion generating tube 21 can be improved due to the decrease of the inner diameter D, the voltage (kV) of the extraction electrode 6 can be further increased, thereby enabling to further increase the ion current (mA) (black dot in FIG. 4). Further, because the stress due to the heat generated in the ion generating tube 21 can be decreased by decreasing the inner diameter D, the ion generating tube 21 is not damaged even if the high frequency power RF is increased. Accordingly, the ion current (mA) can be increased by further increasing the high frequency power RF from 2N (kW) to 4 (kW) and increasing the voltage (kV) of the extraction electrode 6 (black dot in FIG. 4).

In the neutron generating apparatus 1 according to the present invention, when the inner diameter D of the ion generating tube 21 is 20 millimeters, the high frequency power RF is 3.7 kilowatts, the extraction voltage is 6.0 kilovolts, a pulse frequency is 2000 hertz, and a pulse duty is 10%, the peak ion current can be 78 milliamperes.

The deuterium ions or tritium ions extracted from the ion generating tube 21 by the extraction electrode 6 is accelerated by the accelerator 4. The accelerating power source 43 applies the voltage to the accelerating electrode 42. The deuterium ions or tritium ions extracted to the accelerator 4 are attracted to the accelerating electrode 42 applied with the voltage, and are accelerated toward the target 8 in the accelerating electrode 42.

The deuterium ions or tritium ions accelerated by the accelerator 4 are then caused to collide with the target 8 as the ion beams. The collision of the deuterium ions or tritium ions as the ion beams with the target 8 causes a nuclear fusion reaction of the deuterium or tritium occluded in the target 8, and the neutrons are isotropically radiated. The neutrons collide with the detection target object 200 buried in the ground 100. When the neutrons collide with the detection target object 200, the detection target object 200 radiates gamma rays according to the physical properties of the detection target object 200. It can be determined whether the similar detection target object 200 is buried in the ground 100 by detecting the radiated gamma rays by a detector (not shown).

As described above, in the neutron generating apparatus 1 according to the present invention, the ion current for per unit time can be increased. That is, because more deuterium ions or tritium ions can be generated and extracted, the deuterium ions or tritium ions caused to collide with the target can be increased and the generation amount of neutrons per unit time can be increased.

### INDUSTRIAL APPLICABILITY

As described above, the ion generating device and the neutron generating apparatus according to the present invention are useful for an ion generating device that generates deuterium ions or tritium ions and a neutron generating apparatus that generates neutrons from deuterium or tritium, and particularly suitable for increasing the generation amount of neutrons per unit time.

1. An ion generating device comprising:
an ion generating tube to which deuterium gas or tritium gas is supplied;
a magnet arranged outside of the ion generating tube and generates a magnetic field in the ion generating tube;
a plasma generating antenna arranged outside of the ion generating tube and generates an electric field in the ion generating tube; and
a high-frequency power source that supplies high frequency power to the plasma generating antenna,
the high-frequency power source supplying the high frequency power to the plasma generating antenna so that an unsteady state at a time of generating plasma is generated repetitively in the ion generating tube.

2. The ion generating device according to claim 1, wherein the ion generating tube has an inner diameter D in a range equal to or larger than 15 millimeters and equal to or less than 25 millimeters.

3. The ion generating device according to claim 1, wherein the high-frequency power source supplies the high frequency power intermittently to the plasma generating antenna, and a period for supplying the high frequency power once is set as a period for retaining the unsteady state at the time of generating the plasma in the ion generating tube.

4. The ion generating device according to claim 3, wherein the ion generating tube has an inner diameter D in a range equal to or larger than 15 millimeters and equal to or less than 25 millimeters.

5. A neutron generating apparatus comprising:
an ion generating device including an ion generating tube to which deuterium gas or tritium gas is supplied,
a magnet arranged outside of the ion generating tube and generates a magnetic field in the ion generating tube,
a plasma generating antenna arranged outside of the ion generating tube and generates an electric field in the ion generating tube, and
a high-frequency power source that supplies high frequency power to the plasma generating antenna, the high-frequency power source supplying the high frequency power to the plasma generating antenna so that an unsteady state at a time of generating plasma is generated repetitively in the ion generating tube;
a source-gas supplying device that supplies deuterium gas or tritium gas to the ion generating device;
a target arranged opposite to the ion generating device and occludes deuterium or tritium;
an accelerator arranged between the ion generating device and the target and includes an accelerating electrode applied with voltage by an accelerating power source;
a vacuum evacuation system that evacuates the accelerator; and
an extraction electrode arranged between the ion generating device and the accelerator and applied with voltage by an extraction power source.

6. The neutron generating apparatus according to claim 5, wherein as the high frequency power increases, the extraction power source increases the voltage to be applied to the extraction electrode.

7. The neutron generating apparatus according to claim 5, wherein as the inner diameter D of the ion generating tube becomes smaller, the extraction power source increases the voltage to be applied to the extraction electrode.

8. The neutron generating apparatus according to claim 7, wherein as the high frequency power increases, the extraction power source increases the voltage to be applied to the extraction electrode.
